(19) United States
(12) Patent Application Publication
(10) Pub. No.: US 2005/0102406 A1
(43) Pub. Date: May 12, 2005

(54) Automated configuration of a gateway

(75) Inventor: Bruce Moon, Dublin, CA (US)

Correspondence Address: BEYER WEAVER & THOMAS LLP, P.O. BOX 70250, OAKLAND, CA, 94612-0250, US

(73) Assignee: Cisco Technology, Inc., San Jose, CA (US)

(21) Appl. No.: 10/703,868

(22) Filed: Nov. 7, 2003

(51) Int. Cl. G06F 15/16

(52) U.S. Cl. 709/228; 709/223

(57) ABSTRACT

Methods and devices are provided for automatically configuring a gateway. In preferred implementations, a user only needs to connect a new gateway to an existing client device and an existing gateway. Gateways configured according to the present invention automatically analyze communications between the existing client device and the existing gateway to determine existing network parameters. The new gateway then configures itself according to the existing network parameters.

### BACKGROUND OF THE INVENTION

1. Field of the Invention

The present invention relates to network technology. More particularly, the present invention relates to the configuration of gateways.

2. Description of the Related Art

FIG. 1 illustrates a simple network 100, which in this example is a home network. Existing client device 105 (here, a personal computer) was formerly connected to Internet 115 only via existing gateway 107. In this instance, existing gateway 107 is a modem that was supplied by a service provider. Here, new gateway 110 is being installed in order to provide features to existing client device 105 that were not provided by existing gateway 107, such as enhanced firewall capabilities, network address translation capabilities, etc.

When new gateway 110 is installed, it needs to be configured with many settings and network parameters that allow gateway 110 to function properly. Gateway 110 must provide the functionality of existing gateway 107 to existing client device 105 and must also communicate with existing gateway 107 in a fashion similar to the way existing client device 105 was before gateway 110 was installed. Moreover, new gateway 110 must be configured to enable the functionality that the consumer who purchased new gateway 110 is expecting.

However, the consumer will not normally have the sophistication to configure gateway 110 properly. The consumer may or may not be able to follow the directions in an instruction manual for this purpose and would certainly not wish to do so, given an alternative. Moreover, such instruction manuals are expensive for the vendor to compile, publish and update. The vendor may also provide customer support, e.g., via telephone, to assist the consumer in configuring new gateway 110. However, this is a relatively expensive and time-consuming option.

Some gateway vendors have developed software that runs on existing client device 105, finds the required information which is stored on existing client device 105 and then forwards this information to the new gateway 110. This software must be loaded on existing client device 105 by the consumer. The software cannot support every possible client (they are typically limited to recent MS Windows releases) and expose the vendor to customer complaints when this software malfunctions.

It would be desirable to implement improved mechanisms for configuring gateways, particularly for home networks.

### SUMMARY OF THE INVENTION

Methods and devices are provided for automatically configuring a gateway. In preferred implementations, a user only needs to connect a new gateway to an existing client device and an existing gateway. Gateways configured according to the present invention automatically analyze communications between the existing client device and the existing gateway to determine existing network parameters. The new gateway then configures itself according to the existing network parameters.

In accordance with one aspect of the invention, a method of configuring a gateway is provided. The method involves analyzing communications between an existing client device and an existing gateway to determine existing network parameters and automatically configuring a new gateway according to the existing network parameters. The method of claim 1, wherein the existing client device may be a personal computer. The existing gateway may be a modem.

The analyzing step may involve analyzing packets from the existing client device to determine a connection scenario. For example, analyzing step may involve analyzing packets from the existing client device to determine a connection method used when the existing client device attempts to connect to the existing gateway. The method may include the step of sending packets from the new gateway to the existing gateway in conformity with the connection method.

The method may include the step of sending a message to the existing client device proposing a reconfiguration of the existing client device and/or storing the existing network parameters in non-volatile memory accessible to the new gateway. The connection scenario may be, for example, a DHCP connection scenario, a PPP connection scenario or a fixed addressing connection scenario.

Some implementations of the invention provide a computer program embodied in a machine-readable medium. The computer program includes instructions for controlling a new gateway to perform the following steps: analyze communications between an existing client device and an existing gateway to determine existing network parameters; and automatically configure the new gateway according to the existing network parameters. The existing client device may be a personal computer and the existing gateway may be a modem.

The analyzing step may include analyzing packets from the existing client device to determine a connection scenario. The connection scenario may be, for example, a DHCP connection scenario, a PPP connection scenario or a fixed addressing connection scenario. For example, the analyzing step may involve analyzing packets from the existing client device to determine a method used when the existing client device attempts to connect to the existing gateway. The computer program may include instructions for controlling the new gateway to send packets from the new gateway to the existing gateway in conformity with the method.

The computer program may include instructions for controlling the new gateway to send a message to the existing client device proposing a reconfiguration of the existing client device and/or instructions for controlling the new gateway to store the existing network parameters in non-volatile memory accessible to the new gateway.

Alternative embodiments of the invention provide a gateway, including a first port configured for communication with an existing client device and a second port configured for communication with an existing gateway. The gateway also includes one or more processors configured to analyze communications between the existing client device and the existing gateway to determine existing network parameters and automatically configure new network parameters for the gateway according to the existing network parameters. The existing client device may be a personal computer and the existing gateway may be a modem.

One or more processors may also be configured to simulate the existing gateway when communicating with the existing client device via the first port. One or more processors may be further configured to simulate the existing client device when communicating with the existing gateway via the second port.

One or more processors may also be configured to analyze packets from the existing client device to determine a connection scenario, e.g., to analyze packets from the existing client device to determine a method used when the existing client device attempts to connect to the existing gateway. One or more processors may be configured to send a message to the existing client device proposing a reconfiguration of the existing client device.

### BRIEF DESCRIPTION OF THE DRAWINGS

FIG. 1 is a network diagram illustrating a network including an existing client device an existing gateway and a new gateway.

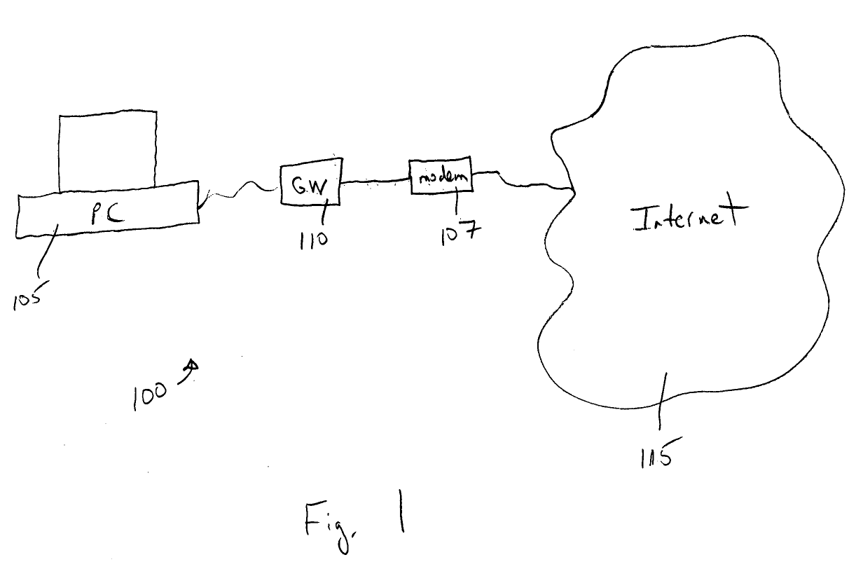

FIG. 2 is a flow chart that outlines a generalized method according to some aspects of the invention.

FIG. 3 is a flow chart that outlines how a user can install a gateway according to some implementations of the invention.

FIG. 4 is a flow chart that outlines a generalized method according to some aspects of the invention.

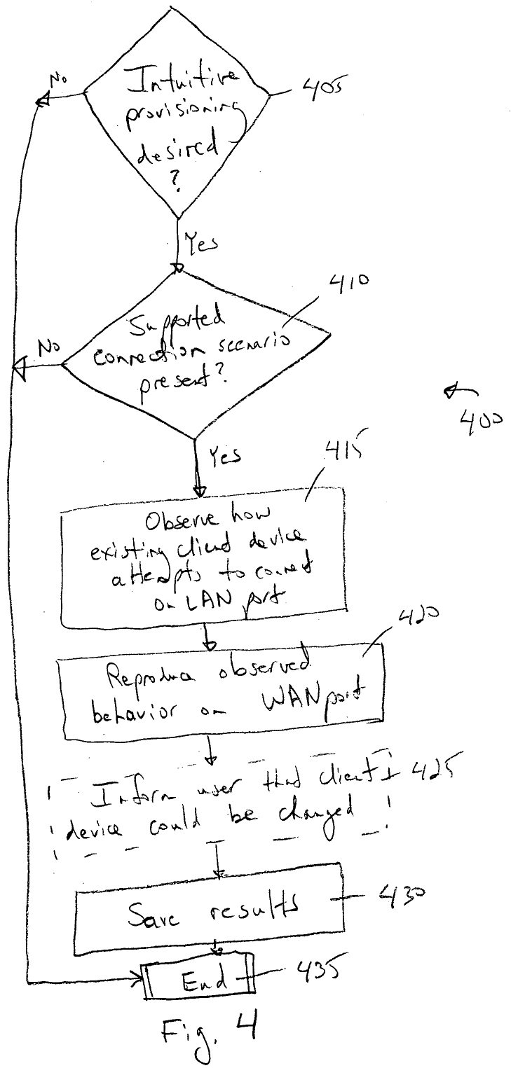

FIG. 5 is a flow chart that outlines a more detailed implementation of some aspects of the invention.

FIG. 6 illustrates a simplified version of a network device that may be configured to implement some aspects of the present invention.

### DETAILED DESCRIPTION OF THE INVENTION

In the following description, numerous specific details are set forth in order to provide a thorough understanding of the present invention. It will be obvious, however, to one skilled in the art, that the present invention may be practiced without some or all of these specific details. In other instances, well known process steps have not been described in detail in order not to unnecessarily obscure the present invention.

Preferred implementations of the invention will discover all of the parameters which are required to configure a new gateway by observing the current connection establishment between an existing client device and an existing gateway (e.g., a modem and/or the service provider's head end infrastructure).

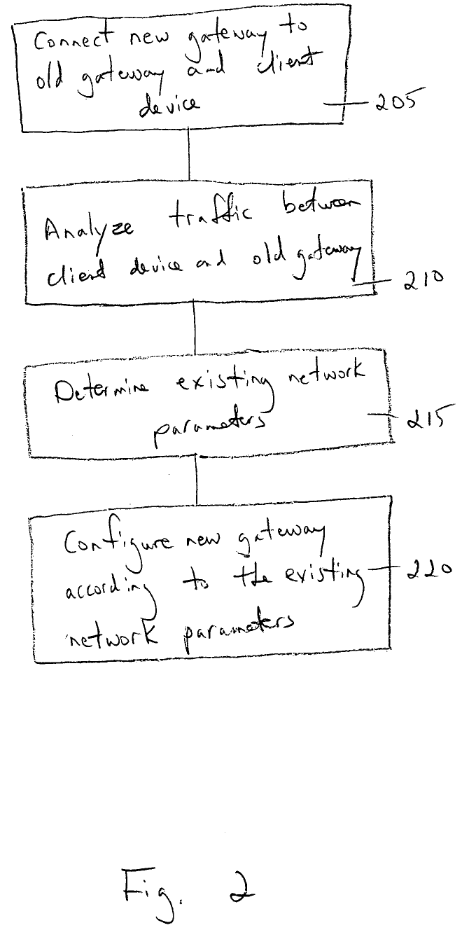

FIG. 2 is a flow chart that provides a high-level description of some implementations of the invention. In step 205, an existing gateway and an existing client device are disconnected and a new gateway is interposed between these devices. After communications resume between the existing gateway and the existing client device, the new gateway analyzes these communications (step 210).

As described in detail below, there may be many aspects to step 210. For example, step 210 involves analyzing packets from the existing client device to determine a connection scenario. In particular, step 210 may involve analyzing packets from the existing client device to determine a method used when the existing client device attempts to connect to the existing gateway.

In step 215, the existing network parameters are determined. As with step 210, the determinations of step 215 may involve a number of individual steps, some of which will be described below. In step 220, the new gateway is configured according to the existing network parameters.

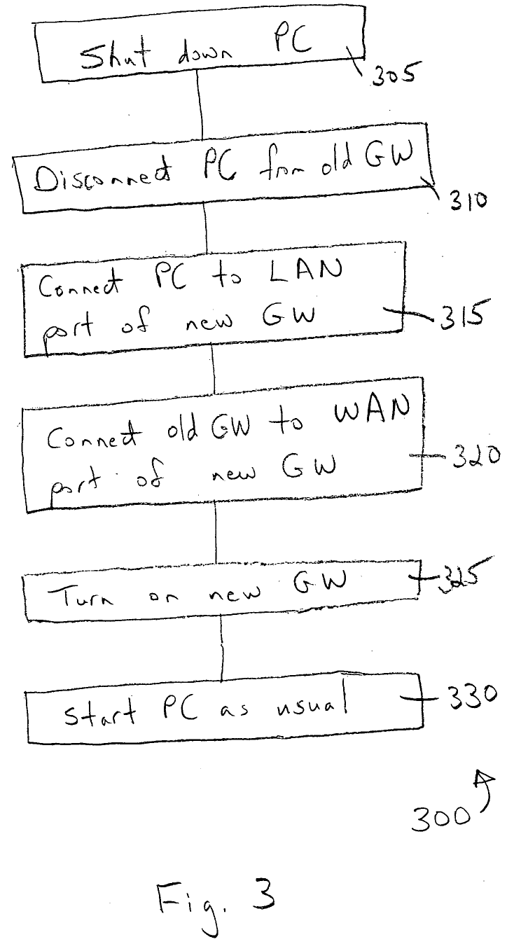

FIG. 3 is a flow chart that outlines how a user can install a gateway according to some implementations of the invention. In this example, the existing client device is a personal computer. Preferably, the existing client device has been connected to an outside network (e.g., the Internet) via the old gateway prior to the steps shown in FIG. 3. However, the steps of method 300 do not necessarily need to occur in the order shown in FIG. 3.

In step 305, the user shuts down the PC in the normal fashion. In step 310, the user disconnects the PC from the old gateway.

The new gateway preferably has a number of ports, including a first port configured for communication with the existing client device and a second port configured for communication with the existing gateway. In this example, the first port is a local area network (“LAN”) port and the second port is a wide area network (“WAN”) port. In step 315, the user connects the PC to the LAN port of the new gateway. The user then connects the old gateway to the WAN port of the new gateway (step 320).

After the new gateway is interposed between the PC and the old gateway, the user turns on the new gateway (step 325), so that the new gateway is ready and able to detect and analyze communications between the PC and the old gateway. Then, the user starts up the PC as he or she normally would (step 330), thereby initializing these communications. The new gateway of the present invention will be able to configure itself according to information determined by an analysis of these communications.

Gateways configured according to the present invention will support as variety of connection scenarios, preferably including as many of the most common connection scenarios as feasible. For example, one embodiment of a gateway according to the present invention supports these common connection scenarios: DHCP (e.g. Cable, ETTx); point-to-point protocol (e.g., PPPoE for DSL connections); and fixed addressing.

According to some implementations of the invention, process 400 through which the gateway automatically configures itself (sometimes referred to herein as “intuitive provisioning”) includes the following steps, each of which is discussed in more detail below. In step 405, the gateway determines whether intuitive provisioning is desired. If not, the process ends (step 435). If so, the process continues to step 410.

In step 410, the gateway discovers which of the supported connection scenarios is present, if any. If none are present, the process ends. If at least one is present, the gateway then observes (by monitoring signals received on the gateway's LAN port) how the existing client attempts to connect to the old/existing gateway (step 415). In step 420, the gateway reproduces (on the gateway's WAN port) the behavior observed in step 415.

In some implementations, the user will be informed that the client device could be advantageously reconfigured (optional step 425). Preferably, the information determined in step 415 will be stored in non-volatile memory (step 430).

Decide if Intuitive Provisioning is Desired:

This feature would probably be initiated whenever no provisioning information to the contrary is present in the device's non-volatile configuration. It might, however, prove to be desirable to only enable this mode of operation by an explicit configuration command. When so activated, this feature would place the new home gateway device into a special mode when it starts up. One example of such a mode is the Cisco IOS “service config” functionality. However, the special mode is not limited to functioning within the IOS context and is therefore dependent upon the capabilities of the underlying platform.

In some cases, as will become more obvious later in this document, it may be advantageous for this feature to have the ability to progressively save its state into a non-volatile configuration in order to facilitate each step of a more involved process. According to some implementations, progressively saving these states allows for the implementation of an interactive process.

Discover Which of the Supported Connection Scenarios is Present:

In general, we look at the packets we receive on a port configured for communication with a client device (e.g., a LAN port) in order to discover the connection scenario. The following discussion assumes that the connection scenario is a DHCP, some form of PPP or a fixed addressing scenario. In order to remain as responsive as possible, while running in this special discovery mode, traffic will be passed unaltered between the two ports.

DHCP

If a DHCP connection scenario has been employed, the gateway would receive DHCP traffic immediately after the reboot. Specifically, the gateway should receive either DHCPREQUEST or DHCPDISCOVER packets from the existing client device.

PPP (e.g., PPPoE)

If a PPP connection scenario is employed, the gateway should receive PPP packets immediately after the client device reboots.

Fixed Addressing

If the new gateway receives nothing but “normal” IP traffic from the existing client device, it will assume, at least temporarily, that the existing client device uses fixed addressing.

Observe How the Existing Client Attempts to Connect on the LAN Port:

Based upon results from the preceding step, one of these processes is followed. In general, the new gateway will capture the pertinent information which will be used in the next step.

DHCP

It should be sufficient to capture the MAC Address and ClientID fields from either the DHCPREQUEST or DHCPDISCOVER packets. If Service Providers change their DHCP environments, other fields might be needed in the future. However, such changes are not anticipated in the next few years. Should this prove necessary, it would probably be convenient to capture all of the observed fields from the client device. During this discovery process, the client device will be assigned an IP address by the DHCP server running on the gateway.

PPP

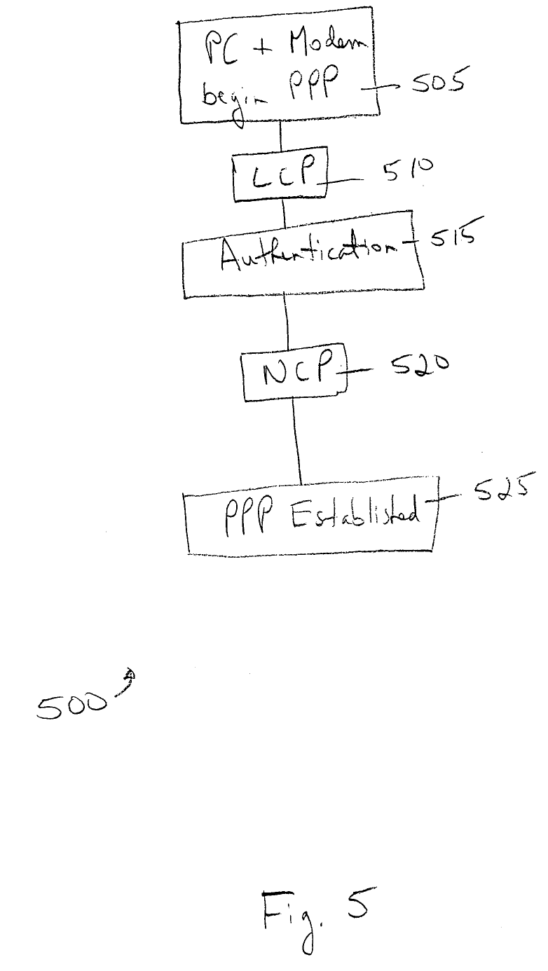

Here, the gateway will need to capture two key variables, the username and the password. As described below with reference to FIG. 5, determining the password may be either trivial or more difficult, depending on the authentication protocol used.

In step 505, the client device (in this example, a PC) and the old gateway (here, a modem) initiate a PPP session. The gateway will receive the initial LCP packets required to establish the PPP connection. When the gateway receives LCP packets, the gateway will then initiate a PPP proxy application that terminates the PC's PPP session and initiates a complementary PPP session with the real server. In essence, the new gateway initiates one PPP session with the PC and initiates another PPP session with the modem. This PPP proxy application in the gateway will simply forward all PPP packets between the two interfaces while analyzing their content.

In step 510, the PC and the modem negotiate various factors, including the maximum receive unit, magic number and also what type of authentication will be used. The username can be recovered trivially from the PPP authentication exchange of step 515. If password authentication protocol (“PAP”) is used, it is also trivial to obtain the password, because the PC will send a packet that indicates both the username and password.

However, if challenge handshake authentication protocol (“CHAP”) is being used the information is harder to obtain. In this case, the PPP proxy would attempt to force PAP authentication with the PC. If that is not successful, the password will not be able to be easily captured, in which case we would need to continue using the PPP proxy until such time as the CHAP secret could be manually entered into the new gateway.

In step 520, the modem and the PC will negotiate all of the required network information (IP addresses, mask information, etc.) according to network control protocol (“NCP”). This information will allow the new gateway to establish the PPP connection in step 525.

Fixed Addressing

If fixed addressing is being used, the new gateway will capture the PC Client default gateway, PC Client and IP Address information during initial address resolution protocol (“ARP”) exchanges, while the LAN and WAN ports are temporarily bridged.

Reproduce That Same Behavior on the WAN Port:

DHCP

The MAC Address and Client ID captured earlier will be used to configure the DHCP client on the WAN port. That DHCP client will then be used to configure the WAN interface.

PPP

If both the username and password were captured earlier, then the WAN PPP client will be configured with the same values for use in the future.

Fixed Addressing

The captured IP Address (I) and Gateway (G) are configured on the WAN interface. These two values are used to compute the minimally inclusive subnet mask (M) for the WAN subnet. In one example, the subnet mask is computed as follows:

M is initialized to 255.255.255.255. If (M and I) does not equal (G and I) then M is shifted left 1 bit and the test repeated. Once they are equal, M has been calculated. For example, the minimally inclusive subnet mask for the WAN subnet, when G is 1.1.1.1 and I is 1.1.1.2 is computed to be 255.255.255.252.

Later, it may become necessary to expand the subnet again, in a similar fashion, should the Gateway respond with ICMP REDIRECTs for other, similar addresses.

In Some Cases, Inform the User that Their PC Can Be Changed:

DHCP

No further action is required.

PPP

If the CHAP secret was not captured earlier, the user will need to enter that value before the new gateway can establish its WAN connection. Also, it would probably be advisable, for performance reasons, to suggest that the user disable the PPP client and re-configure their PC to use DHCP. Once the PC Client is seen to be successfully using DHCP, the PPP proxy application would no longer be needed.

Fixed Addressing

While continued operation in bridge mode might be sufficient for some users, the user should be asked to change their PC Client in order to allow the use of advanced features. They could change to fixed addressing in the LAN subnet or, preferably, to use DHCP. It would then be possible to begin advanced services on the new gateway, such as NAT and routing to a number of client devices.

Record the necessary results:

Preferably, the new gateway stores any captured or discovered values in non-volatile memory. For example, this information would allow the configuration process to continue if the gateway should reboot before the process finishes.

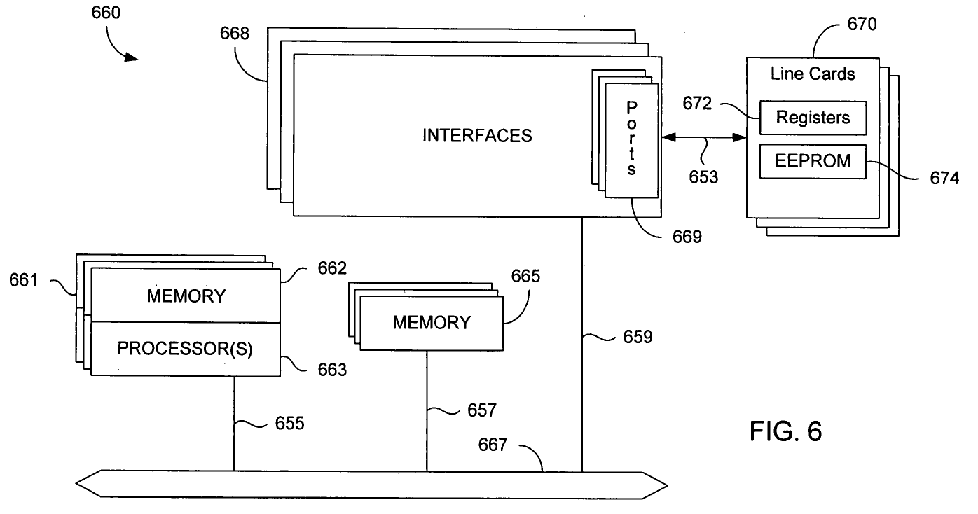

FIG. 6 illustrates an example of a network device that may be configured to implement some methods of the present invention. Network device 660 includes a master central processing unit (CPU) 661, interfaces 668, and a bus 667 (e.g., a PCI bus). Generally, interfaces 668 include ports 669 appropriate for communication with the appropriate media. In some embodiments, one or more of interfaces 668 includes at least one independent processor 670 and, in some instances, volatile RAM. Independent processors 670 may be, for example ASICs or any other appropriate processors. According to some such embodiments, these independent processors 670 perform at least some of the functions of the logic described herein. In some embodiments, one or more of interfaces 668 control such communications-intensive tasks as media control and management. By providing separate processors for the communications-intensive tasks, interfaces 668 allow the master microprocessor 661 efficiently to perform other functions such as routing computations, network diagnostics, security functions, etc.

The interfaces 668 are typically provided as interface cards (sometimes referred to as “linecards”). Generally, interfaces 668 control the sending and receiving of data packets over the network and sometimes support other peripherals used with the network device 660. Among the interfaces that may be provided are FC interfaces, Ethernet interfaces, frame relay interfaces, cable interfaces, DSL interfaces, token ring interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like.

When acting under the control of appropriate software or firmware, in some implementations of the invention CPU 661 may be responsible for implementing specific functions associated with the functions of a desired network device. According to some embodiments, CPU 661 accomplishes all these functions under the control of software including an operating system (e.g., Cisco IOS, a proprietary operating system developed by Cisco Systems, Inc., etc.) and any appropriate applications software.

CPU 661 may include one or more processors 663 such as a processor from the Motorola family of microprocessors or the MIPS family of microprocessors. In an alternative embodiment, processor 663 is specially designed hardware for controlling the operations of network device 660. In a specific embodiment, a memory 662 (such as non-volatile RAM and/or ROM) also forms part of CPU 661. However, there are many different ways in which memory could be coupled to the system. Memory block 662 may be used for a variety of purposes such as, for example, caching and/or storing data, programming instructions, etc.

Regardless of network device's configuration, it may employ one or more memories or memory modules (such as, for example, memory block 665) configured to store data, program instructions for the general-purpose network operations and/or other information relating to the functionality of the techniques described herein. The program instructions may control the operation of an operating system and/or one or more applications, for example.

Because such information and program instructions may be employed to implement the systems/methods described herein, the present invention relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media; and hardware devices that are specially configured to store and perform program instructions, such as read-only memory devices (ROM) and random access memory (RAM). The invention may also be embodied in a carrier wave traveling over an appropriate medium such as airwaves, optical lines, electric lines, etc. Examples of program instructions include both machine code, such as produced by a compiler, and files containing higher level code that may be executed by the computer using an interpreter.

Although the system shown in FIG. 6 illustrates one specific network device of the present invention, it is by no means the only network device architecture on which the present invention can be implemented. For example, an architecture having a single processor that handles communications as well as routing computations, etc. is often used. Further, other types of interfaces and media could also be used with the network device. The communication path between interfaces/linecards may be bus based (as shown in FIG. 6) or switch fabric based (such as a cross-bar).

Other Embodiments

Generally, the techniques of the present invention may be implemented on software and/or hardware. For example, they can be implemented in an operating system kernel, in a separate user process, in a library package bound into network applications, on a specially constructed machine, or on a network interface card. In a specific embodiment of this invention, the technique of the present invention is implemented in software such as an operating system or in an application running on an operating system.

A software or software/hardware hybrid implementation of the techniques of this invention may be implemented on a general-purpose programmable machine selectively activated or reconfigured by a computer program stored in memory. Such a programmable machine may be a network device designed to handle network traffic, such as, for example, the network device described above with reference to FIG. 6. In an alternative embodiment, the techniques of this invention may be implemented on a general-purpose network host machine such as a personal computer or workstation. Further, the invention may be at least partially implemented on a card (e.g., an interface card) for a network device or a general-purpose computing device.

Although illustrative embodiments and applications of this invention are shown and described herein, many variations and modifications are possible which remain within the concept, scope, and spirit of the invention, and these variations would become clear to those of ordinary skill in the art after perusal of this application.

Accordingly, the present embodiments are to be considered as illustrative and not restrictive, and the invention is not to be limited to the details given herein, but may be modified within the scope and equivalents of the appended claims.

1. A method of configuring a gateway, the method comprising:
analyzing communications between an existing client device and an existing gateway to determine existing network parameters; and
automatically configuring a new gateway according to the existing network parameters.

2. The method of claim 1, wherein the analyzing step comprises analyzing packets from the existing client device to determine a connection scenario.

3. The method of claim 1, wherein the analyzing step comprises analyzing packets from the existing client device to determine a connection method used when the existing client device attempts to connect to the existing gateway.

4. The method of claim 1, wherein the existing client device comprises a personal computer.

5. The method of claim 1, wherein the existing gateway comprises a modem.

6. The method of claim 1, further comprising sending a message to the existing client device proposing a reconfiguration of the existing client device.

7. The method of claim 1, further comprising storing the existing network parameters in non-volatile memory accessible to the new gateway.

8. The method of claim 2, wherein the connection scenario is selected from the group consisting of a DHCP connection scenario, a PPP connection scenario and a fixed addressing connection scenario.

9. The method of claim 3, further comprising sending packets from the new gateway to the existing gateway in conformity with the connection method.

10. A computer program embodied in a machine-readable medium, the computer program comprising instructions for controlling a new gateway to perform the following steps:
analyze communications between an existing client device and an existing gateway to determine existing network parameters; and
automatically configure the new gateway according to the existing network parameters.

11. The computer program of claim 10, wherein the analyzing step comprises analyzing packets from the existing client device to determine a connection scenario.

12. The computer program of claim 10, wherein the analyzing step comprises analyzing packets from the existing client device to determine a method used when the existing client device attempts to connect to the existing gateway.

13. The computer program of claim 10, wherein the existing client device comprises a personal computer.

14. The computer program of claim 10, wherein the existing gateway comprises a modem.

15. The computer program of claim 10, further comprising instructions for controlling the new gateway to send a message to the existing client device proposing a reconfiguration of the existing client device.

16. The computer program of claim 10, further comprising instructions for controlling the new gateway to store the existing network parameters in non-volatile memory accessible to the new gateway.

17. The computer program of claim 11, wherein the connection scenario is selected from the group consisting of a DHCP connection scenario, a PPP connection scenario and a fixed addressing connection scenario.

18. The computer program of claim 12, further comprising instructions for controlling the new gateway to send packets from the new gateway to the existing gateway in conformity with the method.

19. A gateway, comprising:
means for analyzing communications between an existing client device and an existing gateway to determine existing network parameters; and
means for automatically configuring a new gateway according to the existing network parameters.

20. A gateway, comprising:
a first port configured for communication with an existing client device;
a second port configured for communication with an existing gateway; and
at least one processor configured to:
analyze communications between the existing client device and the existing gateway to determine existing network parameters; and
automatically configure new network parameters for the gateway according to the existing network parameters.

21. The gateway of claim 20, wherein the at least one processor is further configured to simulate the existing gateway when communicating with the existing client device via the first port.

22. The gateway of claim 20, wherein the at least one processor is further configured to simulate the existing client device when communicating with the existing gateway via the second port.

23. The gateway of claim 20, wherein the at least one processor is further configured to analyze packets from the existing client device to determine a connection scenario.

24. The gateway of claim 20, wherein the at least one processor is further configured to analyze packets from the existing client device to determine a method used when the existing client device attempts to connect to the existing gateway.

25. The gateway of claim 20, wherein the existing client device comprises a personal computer.

26. The gateway of claim 20, wherein the existing gateway comprises a modem.

27. The gateway of claim 20, wherein the at least one processor is further configured to send a message to the existing client device proposing a reconfiguration of the existing client device.

28. The gateway of claim 20, wherein the at least one processor is further configured to store the existing network parameters in non-volatile memory accessible to the gateway.

29. The gateway of claim 21, wherein the connection scenario is selected from the group consisting of a DHCP connection scenario, a PPP connection scenario and a fixed addressing connection scenario.

30. The gateway of claim 22, wherein the at least one processor is further configured to send packets from the gateway to the existing gateway in conformity with the method.
